(19) United States
(12) Patent Application Publication
(10) Pub. No.: US 2015/0123906 A1
(43) Pub. Date: May 7, 2015

(54) KEYBOARD DECK CONTAINED MOTION SENSOR

(71) Applicant: Hewlett-Packard Development Company, L.P., Houston, TX (US)

(72) Inventors: Dimitre D. Mehandjiysky, Cypress, TX (US); Kevin L. Massaro, Houston, TX (US); Ming Chih Kuo, Taipei (TW)

(73) Assignee: Hewlett-Packard Development Company, L.P., Houston, TX (US)

(21) Appl. No.: 14/167,585

(22) Filed: Jan. 29, 2014

Related U.S. Application Data
(63) Continuation of application No. 29/471,487, filed on Nov. 1, 2013.

(51) Int. Cl. G06F 3/023; G06F 3/0354

(52) U.S. Cl. CPC G06F 3/023; G06F 3/03547
USPC 345/168; 345/173

(57) ABSTRACT

An apparatus comprises a keyboard deck having an upper surface and a motion sensor carried within the keyboard deck. The motion sensor comprises a light emitter below the upper surface to emit light in an upward direction and a light sensing device below the upper surface to sense reflections of the light from above the upper surface.

### CROSS-REFERENCE TO RELATED PATENT APPLICATIONS

The present application claims priority under 35 USC 120 and is a continuation of co-pending U.S. patent application Ser. No. 29/471,487 filed on Nov. 1, 2013 by Dimitre D. Mehandjiysky, Kevin L. Massaro and Ming Chih Kuo, and entitled COMPUTER, the full disclosure of which is hereby incorporated by reference.

### BACKGROUND

A motion sensing bar is sometimes used to provide input to a computing device. Such motion sensing bars have cords that are plugged into an external port of the computing device. Use of the motion sensing bar may be difficult in many circumstances.

### BRIEF DESCRIPTION OF THE DRAWINGS

FIG. 1 is a schematic diagram of an example keyboard deck containing a motion sensor.

FIG. 2 is a schematic diagram of an example computing system comprising the keyboard deck of FIG. 1.

FIG. 3 is a flow diagram of an example method that may be carried out by the computing system of FIG. 2.

FIG. 4 is a perspective view of an example implementation of the computing system of FIG. 2.

FIG. 5 is an enlarged fragmentary perspective view of the computing system of FIG. 4 taken along line 5.

FIG. 6 is a perspective view of another example implementation of the computing system of FIG. 2.

FIG. 7 is a perspective view of another example implementation of the computing system of FIG. 2.

FIG. 8 is a fragmentary sectional view of the computing system of FIG. 7.

FIG. 9 is a fragmentary sectional view of the computing system of FIG. 7.

FIG. 10 is a perspective view of another example implementation of the computing system of FIG. 2.

FIG. 11 is a fragmentary sectional view of the computing system of FIG. 8.

FIG. 12 is a fragmentary sectional view of the computing system of FIG. 8.

### DETAILED DESCRIPTION OF THE EXAMPLE EMBODIMENTS

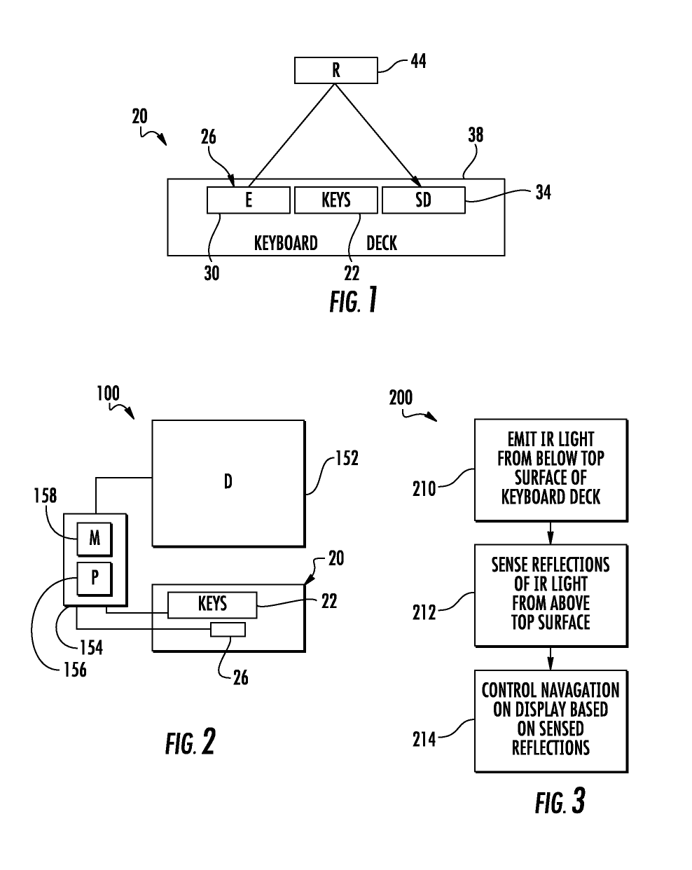

FIG. 1 schematically illustrates an example keyboard deck 20. Keyboard deck 20 provides a keyboard which serves as an input device for a computing device. In one implementation, keyboard deck 20 is incorporated as part of a computing device such as a laptop or notebook computer. In another implementation, keyboard deck 20 is connected to or communicates in a wired or wireless fashion, with a computing device such as a desktop computer, a tablet or the like. As will be described hereafter, keyboard deck 20 facilitates use of motion sensing as a form of input for the computing device, providing such motion sensing with greater consistency and more convenience.

As shown by FIG. 1, in addition to providing keyboard keys 22 (schematically shown), keyboard deck 20 contains a motion sensor 26 within keyboard deck 20. Motion sensor 26 comprises an infrared light emitter 30 and infrared light sensing device 34. Infrared light emitter 30 comprises one or more infrared light emitting devices housed and contained below an upper surface 38 of deck 20. Infrared light emitter 30 emits light in an upward direction into a volume or space contained above upper surface 38 of deck 20. In one implementation, infrared light emitter 30 emits infrared light to form a three-dimensional pattern of infrared light elements or dots above upper surface 38. In one implementation, infrared light emitter 30 comprises one or more infrared light emitting diodes. At least portions of upper surface 38 of deck 20 that overlie emitter 30 are transmissive to infrared light or infrared electromagnetic waves. In one implementation, such portions of upper surface 38 of deck 20 that overlie emitter 30 are transparent.

Infrared light sensing device 34 comprises one or more devices to sense infrared light that has been emitted by emitter 30 and that has been reflected by reflective object 44, such as a person's hand, extending over upper surface 38. In one implementation, light sensing device 34 comprises one or more cameras that capture frames of infrared light reflected off of object 44. At least portions of upper surface 38 of deck 20 that overlie infrared light sensing device 34 are transmissive to infrared light or infrared electromagnetic waves. In one implementation, such portions of upper surface 38 of deck 20 that overlie sensing device 34 are transparent.

In one implementation, infrared light emitter 30 and/or infrared light sensing device 34 are contained within deck 20 below an upper panel forming a part of the upper surface 38 of deck 20. In another implementation, infrared light emitter 30 and/or infrared light sensing device 34 are contained within deck 20 below a lattice surrounding keys 22, wherein the lattice forms a part of the upper surface 38 of deck 20. In yet another implementation, infrared light emitter 30 and/or infrared light sensing device 34 are contained within deck 20 below an upper surface of one or more of keys 22, wherein the upper surface of the one of more keys 22 forms a part of the upper surface 38 of deck 20.

Because motion sensing device 26 is contained within keyboard deck 20, emitter 30 and sensing device 34 of motion sensing device 26 are more consistently positioned relative to the display or other portions of the computing device which utilizes keyboard deck 20. For example, motion sensing bars are relatively small and are extremely mobile, communicating with a computing device in a wireless fashion or merely being tethered to the computing device by a cord. Due to such mobility, motion sensing bars may be positioned at any of a wide range of different positions with respect to a display screen. As a result, hand or other motions by a person using a motion sensing bar may not necessarily yield consistent input performance due to variations in the possible positioning of the motion sensing bar.

In contrast, in implementations where motion sensing device 26 is incorporated as part of a keyboard deck 20 that is fixed to the display, such as with a laptop or notebook computer, the emitter 30 and the sensing device 34 of motion sensing device 26 have consistent, fixed positions relative to the display screen upon which changes brought about by user input are visible. In implementations where motion sensing device 26 is incorporated as part of a keyboard deck that is independent of the computing device, the range of positions that the much larger keyboard deck 20 may be positioned relative to the display screen is much smaller, resulting in less variation in the location of emitter 30 and sensing device 34 relative to the display screen. As a result, a user of motion sensing device 26 may better utilize historical spatial relationships between motion by the person's hands (or other structures) and the display screen upon which the user's attention is focused. Rather than having to adjust his or her input motion every use based upon possibly varying positions of the motion sensing bar during each use, a user may simply focus his or her attention on the display screen and the impact of input. Consequently, use of motion sensing device 26, as incorporated as part of keyboard deck 20, is more intuitive and reliable.

FIG. 2 is a schematic diagram of a computing system 100 comprising keyboard deck 20. In addition to keyboard deck 20, computing system 100 comprises display 152 and controller 154. Display 152 comprises a screen or monitor for presenting graphics and/or text. Such graphics and/or text may vary dependent upon input received or sensed by motion sensor 26. In one implementation, display 152 is a display screen of a tablet. In another implementation, display 152 is a display screen of a desktop computer. In another implementation, display 152 is a display screen of a laptop or notebook computer. In other implementations, display 152 may be part of other computing devices or portable electronic devices which comprise keyboard deck 20.

Controller 154 comprises a device that receives signals from keys 22 and motion sensor 26 and that generates control signals based upon such signals that may result in the images and/or text being presented by display 152 to change. Controller 154 comprises processor 156 and memory 158. Processor 156 comprises one or more processing units configured to receive signals from keys 22 and motion sensor 26, to analyze such signals and to generate control signals based upon such signals and based upon instructions contained in memory 158.

For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 154 may be embodied as part of one or more application-specific integrated circuits (ASICs). Unless otherwise specifically noted, the controller is not limited to any specific combination of hardware circuitry and software, nor to any particular source for the instructions executed by the processing unit.

Memory 158 comprises a non-transitory computer-readable medium or circuitry embodying computer-readable code or programming to direct processor 156 in the generation of control signals based upon the signals received from motion sensor 26. In one implementation, memory 158 and processor 156 may be incorporated and contained within keyboard deck 20. In another implementation, memory 158 and processor 156 may be incorporated in a separate housing independent of keyboard deck 20. In one implementation, memory 158 directs processor 156 to carry out method 200 of FIG. 3.

FIG. 3 is a flow diagram of an example method 200 that may be carried out by computing system 100. As indicated by step 210, emitter 30 of motion sensor 26 within keyboard deck 20 emits infrared light from below top surface 38 (shown in FIG. 1) in an upward direction into a volume overlying keyboard deck 20. In one implementation, emitter 30 emits infrared light in a three-dimensional grid or pattern overlying keyboard deck 20.

As indicated by step 212, infrared sensing device 34 within keyboard deck 20 and below upper surface 38 senses reflections of infrared light from locations spaced above the top or upper surface 38 of keyboard deck 20. In one implementation, infrared sensing device 34 comprises one or more cameras which capture frames or images of reflected light. In one implementation, infrared sensing device 34 captures frames at a rate of 300 frames per second. Signals representing such frames are transmitted to controller 154.

As indicated by step 214, processor 156 receives the signals from sensing device 26 and analyzes such signals to detect and determine motion in the volume of space lying above and spaced from upper surface 38. Based upon the determined motion, such as positioning and/or movement of a person's hand or hands in the volume of space overlying and spaced above upper surface 38, or the sensed reflections of infrared light, processing unit 46 (following instructions contained in memory 158) generates control signals which control navigation on display 152. Such “navigation” may comprise movement of a cursor, movement of an image, rotation of an image, creation or removal of an image and/or enlargement/reduction of an image.

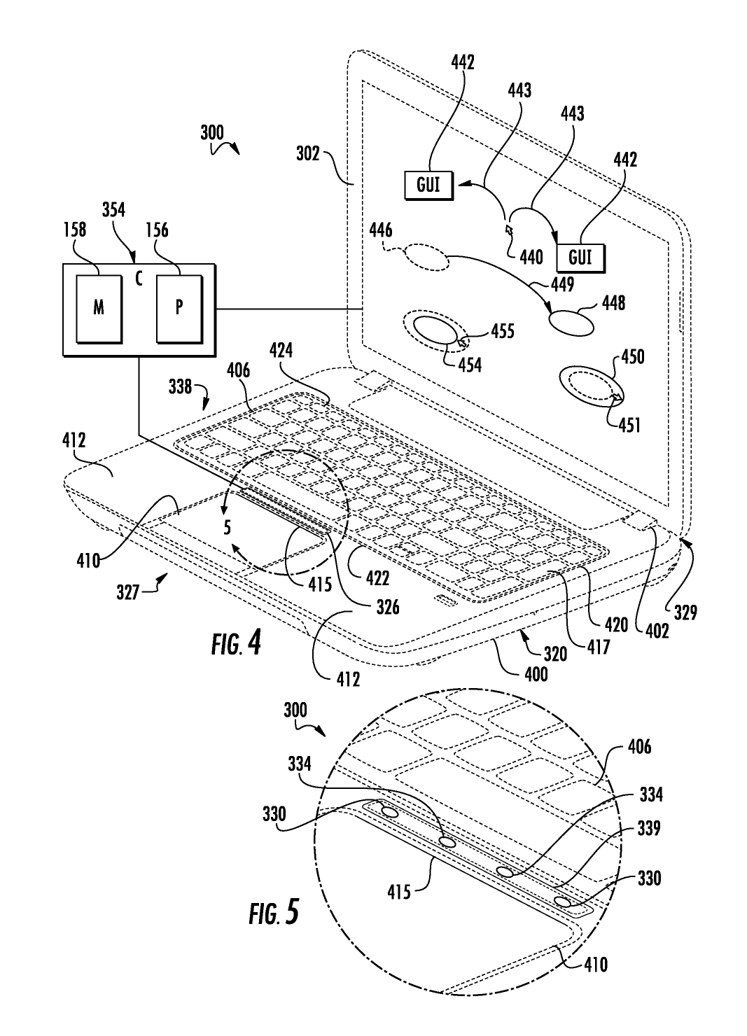

FIGS. 4 and 5 illustrate computing system 300, an example implementation of computing system 100. Computing system 300 comprises a laptop computer or computing device comprising display 302, a keyboard deck 320, motion sensor 326 and controller 354. Display 302 is similar to display 152. In the example illustrated, display 302 is physically coupled to and carried by keyboard deck 320. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. In the example illustrated, display 302 is pivotably coupled to or hinged to keyboard deck 320. In other implementations, display 302 may be removably clipped, snapped or otherwise physically connected to keyboard deck 320. Because display 302 is physically coupled to keyboard deck 320 which contains motion sensor 326, motion sensor 326 is always located at the exact same location relative to display 302 such that a user of motion sensing device 326 may better utilize historical spatial relationships between motion by the person's hands (or other structures) and the display 302 upon which the user's attention is focused.

Keyboard deck 320 is similar to keyboard deck 20. Keyboard deck 320 has a front edge 327 and an opposite rear edge 329 coupled to display 302. Keyboard deck 320 comprises outer housing 400, display mounting portion 402, keys array 406 and touchpad 410. Outer housing 400 comprises one or more panels or other structures that support, cover, shield or enclose electronic componentry of computing system 300. Housing 400 comprises a pair of palm rest panels 412 on opposite sides of touch pad 410 upon which a person may rest his or her palms when utilizing key array 406. Housing 400 further comprises one or more openings for exposing and/or receiving key array 406, touchpad 410 and motion sensor 326.

Display mounting portion 402 extends at the rear edge 329 of keyboard deck 320 and couples display 302 to keyboard deck 320 at a rear edge 329. In the example illustrated, display mounting portion 402 comprises a hinge mechanism. In other implementations, display mounting portion 402 may have other structures configured to clip, mount, slide are otherwise connect display 302 to rear edge 329 of keyboard deck 320.

Key array 406 comprises an array of keys serving as a keyboard for computing system 300. In one implementation, key array 406 comprises an array of QWERTY keys. In another implementation, key array 406 comprises other arrangements of the keys. In one implementation, the keys of key array 406 are depressable. In another implementation, the keys of key array 406 are actuatable or selected for input in other manners. As shown by FIG. 4, the keys of key array 406 are clustered within a key array having an outer perimeter 417, wherein array 406 is located within an equally sized or larger sized window 418 within housing 400 and having an outer rectangular perimeter or outline 420 with a frontward most edge 422 proximate to touchpad 410 and a rearward most edge 424 proximate to rear edge 329. In one implementation, window 418 contains array 406 and any lattice, if any, surrounding and extending between individual keys or groups of keys of array 406. In some implementations, window 418 may be omitted, wherein the keys of array 406 extend through housing 400 itself.

Touchpad 410 comprise a pad sensitive to touch to receive input based upon manual touching of or contact with pad 410. Such input may be in the form of a person sliding his or her finger or fingers across the surface of touchpad 410 or in the form of a person tapping the surface of touchpad 410. Touchpad 410 extends between key array 406 and front edge 327 of keyboard deck 320. Together, the upper surface of housing 400, including palm rest panels 412, key array 406 and touchpad 410 form an upper surface 338 of keyboard deck 320.

Motion sensor 326 is similar to motion sensor 26. As with motion sensor 26, motion sensor 326 comprises infrared light emitter 330 and infrared light sensing devices 334 (shown in FIG. 5). Infrared light emitters 330 comprise infrared light emitting devices housed and contained below an upper surface 338 of deck 320. Infrared light emitter 330 emits light in an upward direction into a volume or space contained above upper surface 338 of deck 20 between front edge 327 and rear edge 329. In one implementation, infrared light emitters 330 emit infrared light to form a three-dimensional patterning of infrared light elements or dots above upper surface 38 between front edge 327 and front edge 424 of key array 406. In one implementation, infrared light emitters 330 comprise one or more infrared light emitting diodes. At least portions of upper surface 338 of deck 20 that overlie emitter 330 are transmissive to infrared light or infrared electromagnetic waves. In one implementation, keyboard deck 320 comprises a transparent panel 339 that overlies emitters 330.

Infrared light sensing devices 334 comprise devices to sense infrared light that has been emitted by emitters 330 and that has been reflected by a reflective object, such as a person's hand, extending over upper surface 338. In one implementation, light sensing devices 334 comprise cameras that capture frames of reflected infrared light. At least portions of upper surface 338 of deck 320 that overlie infrared light sensing devices 334 are transmissive to infrared light or infrared electromagnetic waves. In one implementation, transparent panel 339 also overlies sensing device 334.

In the example illustrated in FIGS. 4 and 5, infrared light emitters 330 and infrared light sensing devices 334 are located at longitudinal locations that are between the collective rear edge 424 of key array 406 and the rear edge 415 of touchpad 410. For purposes of this disclosure, the term “longitudinal” refers to a direction extending perpendicular to front edge 327 and rear edge 329. In the example illustrated, infrared light emitters 330 and infrared light sensing devices 334 of motion sensor 326 have longitudinal locations that are between front edge 422 of key array 406 and rear edge 415 of touch pad 410. In one implementation, the longitudinal positions of emitters 330 and sensing device 334 are centered between touchpad 410 and key array 406.

Because emitters 330 and sensors 334 have longitudinal positions between rear edge 424 of key array 406 and rear edge 415 of touchpad 410, emitter 330 and sensors 334 are able to detect motion within a spatial volume spaced above keyboard deck 420 that is intuitive to a person using motion sensor 326 when viewing display 302. By being located in front of rear edge 424 of key array 406, the spatial volume in which motion is sensed is sufficiently spaced from display 302 to detect motion of a person's palms. At the same time, by being located in front of rear edge 415 of touchpad 410, the spatial volume which motion is sensed by the combination of emitters 330 and sensor 334 is less likely to detect extraneous motion or noise such as a user's torso or other persons passing nearby. Moreover, motion sensing device 326 is also less likely to interfere with the use of touchpad 410 or use of the surfaces provided by palm rest panel portions 412.

Controller 354 is similar to controller 54. Controller 354 comprises processor 156 and memory 158, described above. As shown by FIG. 4, in response to receiving signals from motion sensor 326 indicating reflections of infrared light emitted by emitters 330 and detected by sensors 334, processor 156, following instructions contained in memory 158, identifies and determines any motion that is occurred in the spatial volume above keyboard deck 320. Based upon the detected motion, processor 156 generates control signals to control navigation on display 302. Such navigation may comprise movement of a cursor 440 between different graphical user interfaces 442 as indicated by arrows 443. Such navigation may comprise movement of an icon, drawing, graphic or image 448 from a first position to a second position as indicated by arrow 449. Such navigation may comprise the enlargement of an icon, drawing, graphic or image 450 as indicated by arrow 451 or the reduction of an image 454 as indicated by arrow 455. Such navigation may comprise the selection of text or graphics through highlighting placed based upon such sensed motion. In yet other implementations, such navigation may involve other changes to the text or graphics presented on display 302 in response to detected motion above keyboard deck 320. Such detected motor may also involve changes to data being analyzed or data being stored by computing system 300.

Although controller 354 is schematically illustrated as being distinct from keyboard deck 320, in the example illustrated, controller 354 is house or contained within housing 400 of keyboard deck 320. In other implementations, controller 354 may be housed or contained independent of keyboard deck 320. For example, in some implementations in which display 302 is separable from keyboard deck 320 or is independent of keyboard deck 320, such as when display 302 comprises part of a tablet computer, controller 354 may be housed as part of display 302.

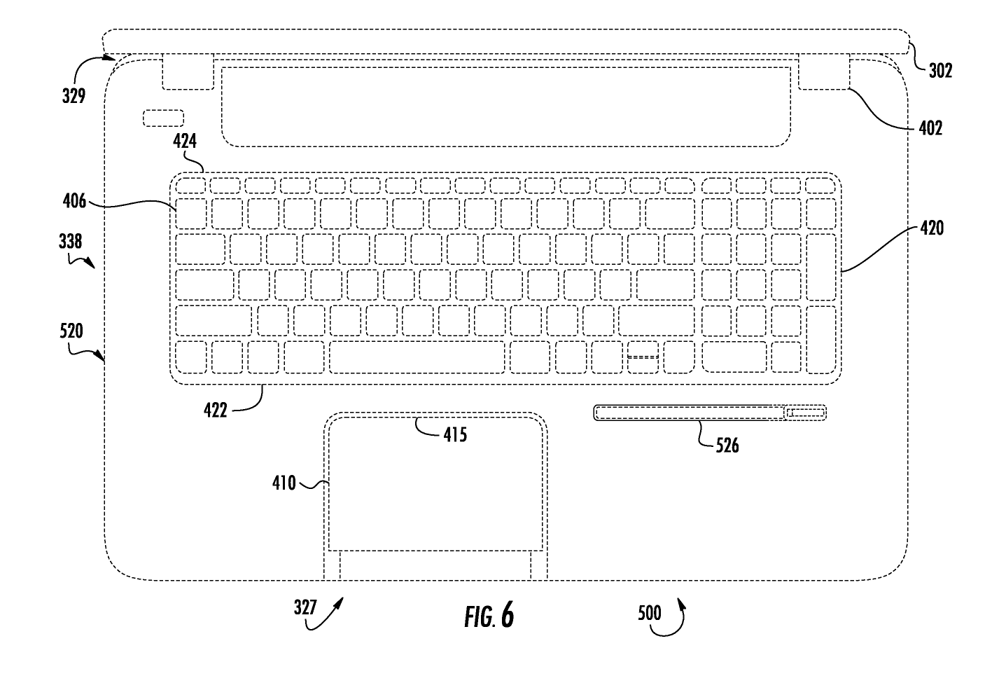

FIG. 6 illustrates computing system 500, another example implementation of computing system 100. Computing system 500 is similar to computing system 300 except that computing system 500 comprises keyboard deck 520 and motion sensor 526 instead of keyboard deck 420 and motion sensor 326. Those remaining elements of computing system 500 which are also found in computing system 300 are numbered similarly in FIG. 6 or are shown in FIGS. 4 and 5.

Keyboard deck 520 is similar to keyboard deck 420 except that keyboard deck 520 accommodates the different location of motion sensor 526. Motion sensor 526 is similar to motion sensor 326 except that motion sensor 526 is located to a side of touchpad 410. As with motion sensor 326 of computing system 300, motion sensor 526 of computing system 500 has emitters 330 and light sensors 334 (shown in FIG. 5) that have longitudinal locations that are between front edge 422 of key array 406 and rear edge 415 of touch pad 410. By being located in front of rear edge 424 of key array 406, the spatial volume in which motion is sensed is sufficiently spaced from display 302 to detect motion of a person's palms. At the same time, by being located in front of rear edge 415 of touchpad 410, the spatial volume which motion is sensed by the combination of emitters 330 and sensor 334 is less likely to detect extraneous motion or noise such as a user's torso or other persons passing nearby. Moreover, sensor 526 is also less likely to interfere with the use of touchpad 410 or use of the surfaces provided by palm rest panel portions 412.

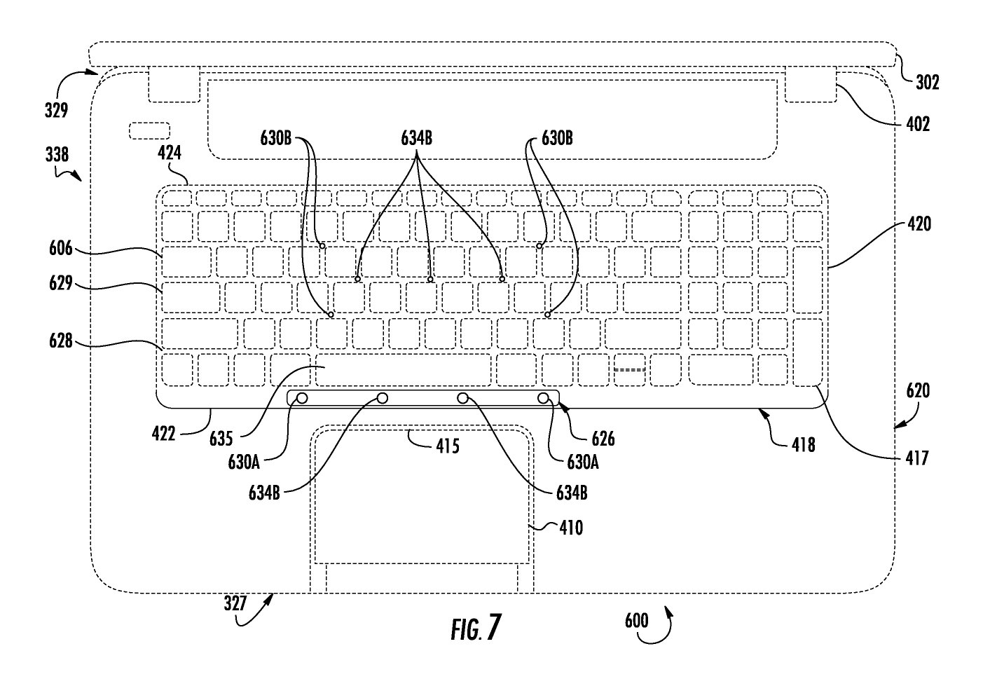

FIGS. 7-9 illustrate computing system 600, another example implementation of computing system 100. Computing system 600 is similar to computing system 300 except that computing system 600 comprises keyboard deck 620 having key array 606 and motion sensor 626 in place of key array 406 and motion sensor 326, respectively. Those remaining components of computing system 600 which correspond to components of computing system 300 are numbered similarly or are shown and described in FIGS. 4 and 5.

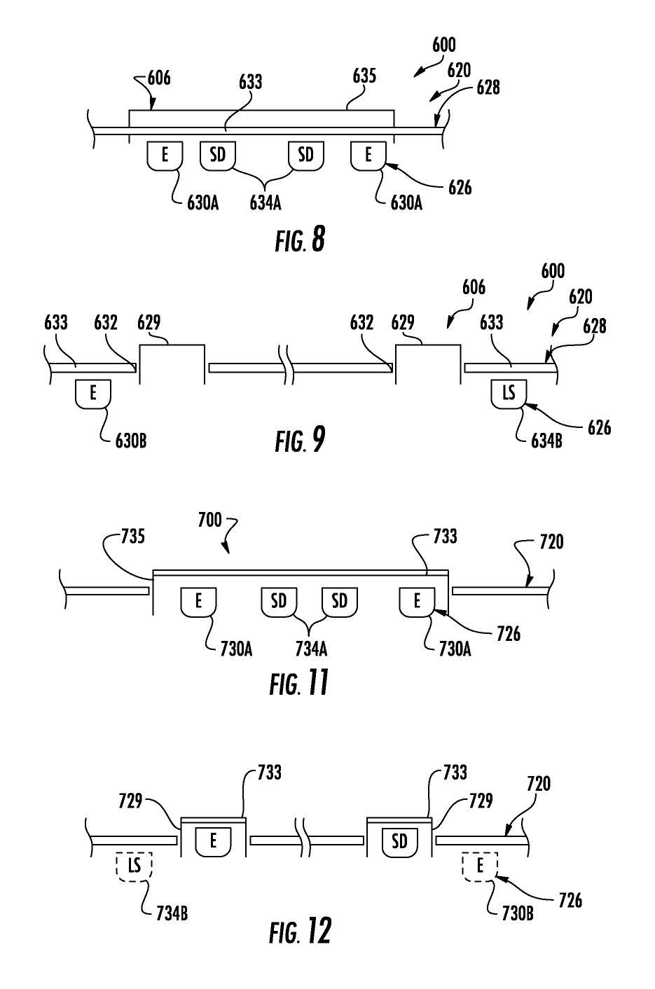

Key array 606 is similar to key array 406 except that key array 606 is specifically illustrated as being surrounded by a lattice 628 extending about the individual keys 629 of the array 606. Lattice 628 comprises a multi-opening framework having openings 632 through which the individual keys 629 or individual clusters of keys 629 of array 606 extend. Lattice 628 forms a grill about the individual keys 629 or groups of keys 629 that reduces a likelihood of debris falling between the individual keys 629. As shown by FIGS. 8 and 9, portions 633 of lattice 628 overlie portions of motion sensor 626. Portions 633 of lattice 633 are transmissive to light emitted by motion sensor 626. In one implementation, portions 633 of lattice 628 are transparent. In one implementation, such portions of lattice 633 are transmissive to infrared light emitted through such transmissive portions 633, reflected off of an object, such as a person's hand, and reflected back through transmissive portions 633 of lattice 628.

Motion sensor 626 is similar to motion sensor 326 except that motion sensor 626 is contained within the outer perimeter 420 of key array 606. Motion sensor 626 comprises infrared light emitters 630A (shown in FIGS. 7 and 8) and 630B (shown in FIGS. 7 and 9) (collectively referred to as emitters 630), and light sensing devices 634A (shown in FIGS. 7 and 8) and 634B (shown in FIGS. 7 and 9) (collectively referred to as sensing devices 634). Emitters 630 and sensing devices 634 are similar to emitters 30, 330 and sensing devices 34, 134 described above, but for their specifically illustrated locations. In the example illustrated, emitters 630A and sensing devices 634A are located below lattice 628 in front of the front most key of key array 606. In the example illustrated, emitters 630A and sensing devices 634A are located below lattice 628 in front of a space bar key 635 of key array 606 and rearward of front edge 415 of touchpad 410. In the example illustrated, emitters 630B and sensing devices 634B are located below lattice 628 amongst and between individual keys 629 of key array 606.

Because emitters 630A and sensing devices 634A are located below lattice 628 in front of the front most keys 629 of key array 606, emitters 630A and sensing devices 634A sense motion in a spatial volume sufficiently close to front edge 327 to sufficiently capture a user's palm. Moreover, the provision of emitters 630A and sensing devices 634A in front of the front most keys 629 of array 606 is less likely to interfere with the spacing between key array 606. Because emitters 630B and sensing devices 634B are located between the individual keys 629 of array 606, emitters 630B and sensing devices 634B may located across a wider area along the upper surface 338 of keyboard deck 620. Because emitters 630 and sensing devices 634 are located within the outer perimeter 420 of key array 606, utilizing the space provided by lattice 628, motion sensor 626 consumes less valuable real estate along the upper surface of keyboard deck 620.

In one implementation, computing system 600 is configured to provide the user with the ability to adjust or select (through user input) which of emitters 630 and which of sensing devices 634 are utilized. For example, in one mode, user may select to utilize emitters 630A and sensing devices 634A while emitters 630B and sensing devices 634B are not active. In another mode, the user may alternatively select to utilize emitters 630B and sensing devices 634B while emitters 630A and sensing devices 634A are not active. In yet other implementations, motion sensor 626 may comprise one of the pair of emitters 630A, sensing devices 634B and emitters 630B and sensing devices 634B. In other implementations, emitters 630 and sensing devices 634 may have other locations below lattice 628 within perimeter 640 of key array 606.

FIGS. 10-12 illustrate computing system 700, another example implementation of computing system 100. Computing system 700 is similar to computing system 300 except that computing system 700 comprises keyboard deck 720 having key array 706 and motion sensor 726 in place of key array 406 and motion sensor 326, respectively. Those remaining components of computing system 700 which correspond to components of computing system 300 are numbered similarly or are shown and described in FIGS. 4 and 5.

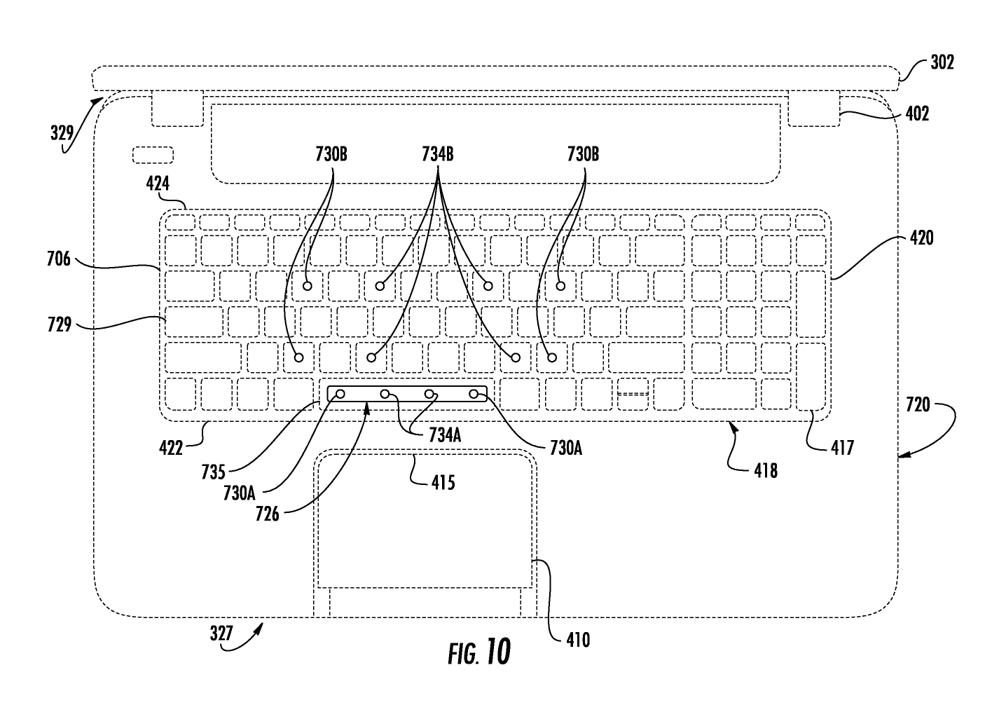

Key array 706 is similar to key array 406 except that key array 606 is specifically illustrated as having individual keys 729 of the array 606 that contain or overlie portions of motion sensor 726. As shown by FIGS. 11 and 12, portions 733 of individual keys 729 overlie portions of motion sensor 626. Portions 733 are transmissive to light emitted by motion sensor 726. In one implementation, portions 733 of key 0729 are transparent. In one implementation, such portions of keys 729 are transmissive to infrared light emitted through such transmissive portions 733, reflected off of an object, such as a person's hand, and reflected back through transmissive portions 733 of keys 729.

Motion sensor 726 is similar to motion sensor 326 except that motion sensor 726 is contained within the outer perimeter 420 of key array 606. Motion sensor 626 comprises infrared light emitters 730A (shown in FIG. 1011) and 730B (shown in FIGS. 10 and 12) (collectively referred to as emitters 730), and light sensing devices 734A (shown in FIGS. 1011) and 734B (shown in FIGS. 10 and 12) (collectively referred to as sensing devices 634). Emitters 730 and sensing devices 734 are similar to emitters 30, 330 and sensing devices 34, 134 described above, but for their specifically illustrated locations. In the example illustrated, emitters 730A and sensing devices 734A are located below the upper surface of a front most key 729 of array 706. In the example illustrated, emitters 730A and sensing devices 734A are located within space bar key 735 of key array 706 and rearward of front edge 415 of touchpad 410. In the example illustrated, emitters 730B and sensing devices 734B are located below the upper surfaces of character/number keys 729 of key array 706.

Because emitters 730A and sensing devices 734A are located within our below front most keys 729 of key array 706, emitters 730A and sensing devices 734A sense motion in a spatial volume sufficiently close to front edge 327 to sufficiently capture a user's palm. Moreover, the larger size of space bar key 735 better accommodates the provision of both emitters 730A and sensing devices 734A. Because emitters 730B and sensing devices 734B are distributed amongst multiple individual keys 729 of array 606 that are spaced apart from one another, emitters 730B and sensing devices 734B may be located across a wider area along the upper surface 338 of keyboard deck 720, providing a larger spatial volume for detecting user input motion. Because emitters 730 and sensing devices 734 are located within the outer perimeter 420 of key array 706, utilizing the space provided by keys 629, motion sensor 726 consumes less valuable real estate along the upper surface of keyboard deck 720.

In one implementation, computing system 700 is configured to provide the user the ability to adjust or select which of emitters 630 in which of sensing devices 734 are utilized. For example, in one mode, user may select to utilize emitters 730A and sensing devices 734A while emitters 730B and sensing devices 734B are not active. In another mode, the user may alternatively select to utilize emitters 730B and sensing devices 734B while emitters 730A and sensing devices 734A are not active. In yet other implementations, motion sensor 726 may comprise one of the pair of emitters 730A, sensing devices 734B and emitters 630B, sensing devices 734B. In other implementations, emitters 630 and sensing devices 634 may have other locations below the upper surface of other keys 729 of key array 706. In yet some implementations, infrared light emitters and infrared light sensing devices may be provided below surfaces of both individual keys 729 and the surrounding lattice 628, if provided.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a keyboard deck having an upper surface; and
a motion sensor contained within the keyboard deck, the motion sensor comprising:
a light emitter below the upper surface to emit light in an upward direction; and
a light sensing device below the upper surface to sense reflections of the light from above the upper surface.

2. The apparatus of claim 1 further comprising a controller in communication with the infrared light sensing device, the controller to generate control signals controlling navigation of a cursor on a display based upon the sensed reflections of the light.

3. The apparatus of claim 1, wherein the keyboard deck comprises:
an array of keys having a collective front edge and a collective rear edge;
a touchpad between the collective front edge of the array of keys and a front edge of the keyboard deck, wherein the motion sensor has a longitudinal location that is between the collective rear edge of the array of keys and the touchpad.

4. The apparatus of claim 3, wherein the motion sensor is transversely located to a side of the touch pad.

5. The apparatus of claim 3 further comprising a lattice about the array of keys, the lattice comprising a transparent portion, wherein one of the light emitter and the light sensing device underlies the transparent portion.

6. The apparatus of claim 5, wherein the other of the light emitter and the light sensing device also underlies the transparent portion.

7. The apparatus of claim 5, wherein the array of keys comprises a space bar and wherein the transparent portion of the lattice extends in front of the space bar.

8. The apparatus of claim 1 further comprising an array of keys comprising a first key having a transparent upper portion, wherein one of the light emitter and the light sensing device underlies the transparent upper portion.

9. The apparatus of claim 8, wherein the other of the light emitter and the light sensing device also underlies the transparent portion.

10. The apparatus of claim 9, wherein the first key comprises a space bar of the array of keys.

11. The apparatus of claim 8, where the array of keys comprises a second key having a second transparent upper portion, wherein the other of the light emitter and the light sensing device underlies the second transparent upper portion.

12. A method comprising:
emitting light from an emitter contained within the keyboard deck below a top surface of the keyboard deck;
sensing reflections of the light from above the top surface of the keyboard deck; and
controlling navigation on a display based upon the sensed reflections of the light.

13. The method of claim 12, wherein the keyboard deck comprises:
an array of keys having a collective front edge and a collective rear edge; and
a touchpad between the collective front edge of the array of keys and a front edge of the keyboard deck, wherein the reflections are sensed from a longitudinal location that is between the collective rear edge of the array of keys and the touchpad.

14. An apparatus comprising:
a keyboard deck having an array of keys within a window having an outer perimeter; and
a motion sensor carried within the keyboard deck within the outer perimeter.

15. The apparatus of claim 14, wherein at least portions of the motion sensor are contained within a key of the array of keys.
